(19) United States
(12) Patent Application Publication
(10) Pub. No.: US 2024/0160152 A1
(43) Pub. Date: May 16, 2024

(54) HOLOGRAPHIC DISPLAY SYSTEM AND METHOD FOR REDUCING EFFECTS OF QUANTISATION NOISE

(71) Applicant: VividQ Limited, London (GB)

(72) Inventors: Christian FIELDHOUSE, London (GB); Alfred James NEWMAN, London (GB)

(21) Appl. No.: 18/416,480

(22) Filed: Jan. 18, 2024

Related U.S. Application Data
(63) Continuation of application No. PCT/GB2022/051867, filed on Jul. 19, 2022.

(30) Foreign Application Priority Data
Jul. 21, 2021 (GB) 2110495.5

(51) Int. Cl. G03H 1/12; G03H 1/02; G03H 1/22; G03H 1/26

(52) U.S. Cl. CPC G03H 1/12; G03H 1/02; G03H 1/2205; G03H 1/2645; G03H 2001/0212; G03H 2001/0224; G03H 2001/2207; G03H 2001/2655; G03H 2223/55

(57) ABSTRACT

A holographic display system comprises a light source configured to emit at least partially coherent light; a modulator arranged to be illuminated by the at least partially coherent light and to generate a light field which is a quantised representation of a target light field, H; and a spatial filter delimiting an aperture in a Fourier plane. A Fourier transform of the target light field, F(H), substantially does not overlap (i) a Fourier transform of a complex conjugate of the target light field, F(H*), (ii) a Fourier transform of the target light field multiplied by the complex conjugate of the target light field, F(HH*), (iii) a Fourier transform of a square of the target light field, F(H²), and (iv) a Fourier transform of a square of the complex conjugate of the light field F(H*²). The aperture substantially corresponds to F(H) in the Fourier plane.

### CROSS-REFERENCE TO RELATED APPLICATIONS

This application is a continuation under 35 U.S.C. § 120 of International Application No. PCT/GB2022/051867, filed Jul. 19, 2022 which claims priority to United Kingdom Application No. GB 2110495.5, filed Jul. 21, 2021, under 35 U.S.C. § 119(a). Each of the above-referenced patent applications is incorporated by reference in its entirety.

### BACKGROUND

### Technical Field

The present invention relates to holography and methods of generating holographic images.

### Background

Computer Generated Holography, CGH, is known. A holographic light field is determined for display using coherent or at least partially coherent light and is defined in terms of an amplitude and phase of each element (pixel) of a display. This combination results in a light field perceived with depth information by a viewer. An ideal holographic display for such a light field is capable of full-complex modulation where the amplitude and phase values at each pixel of the hologram can be varied to very closely resemble the determined amplitude and phase of the light field. In other words, an ideal holographic display is capable of displaying all possible combinations of phase and amplitude.

In practice, displays used for CGH cannot achieve perfect full-complex modulation. Typical displays used for CGH may only have a very limited number of values they can display. For example, the displays may only be capable of modulating one of amplitude or phase. The resolution may also be limited, perhaps to 5 bits of resolution (giving 32 possible displayed values or fewer), even only 2 values in the case of a binary display technology.

As a result, pixels of a full-complex holographic image are quantised for display, to a value that can be reproduced by the display. For example, in the extreme case of a binary display (such as a Digital Micromirror Device, DMD) each pixel in the display can only be in one of two states. All points on the full-complex Argand diagram need to be mapped to one of the two states.

The process of quantisation for display reduces the image quality, visible in the perceived image as reduced contrast and/or noise.

It is known to improve the quality of quantised holograms for display through iterative methods such as the Gerchberg Saxton algorithm. However, these methods require many iterations (perhaps 100 or more) and so require significant processing resources and/or power. This is especially apparent for moving holograms, where such iterative methods may reduce a frame rate and/or introduce a lag.

It would be desirable to improve the image quality of CGH displays with reduced requirements for processing resources and/or power.

### SUMMARY

According to a first aspect of the present invention, there is provided a holographic display system comprising: a light source configured to emit at least partially coherent light; a modulator arranged to be illuminated by the at least partially coherent light; and a spatial filter delimiting an aperture in a Fourier plane. A Fourier transform of the target light field, F(H), substantially does not overlap (i) a Fourier transform of a complex conjugate of the target light field, F(H*), (ii) a Fourier transform of the target light field multiplied by the complex conjugate of the target light field, F(HH*), (iii) a Fourier transform of a square of the target light field, F(H²), and (iv) a Fourier transform of a square of the complex conjugate of the light field F(H*²); and the aperture substantially corresponds to F(H) in the Fourier plane.

Such a construction can improve an image quality of displayed holograms by the combination of limitation on an extent of the target light field in the Fourier plane (by defining that it cannot overlap the Fourier transform of its complex conjugate and the higher order terms) and the positioning of the aperture to correspond to F(H) in the Fourier plane. By F(H) it is meant the part of the Fourier plane which has non-zero values. It has been found that this arrangement prevents additional components in the Fourier plane that are introduced by quantisation for display. Furthermore, determining H in this way is computationally simpler than prior iterative methods, such as Gerchberg Saxton, reducing requirements for processing resources. This can allow higher quality holographic displays with reduced processing and/or power requirements, allowing displays to be one or more of lower-cost, more portable, and for battery-powered devices, of increased battery life.

As will be explained in more detail later, the inventors have realised that noise introduced by quantisation for display results in additional components in the Fourier plane that are approximated by a series expansion. By considering additional terms of the series expansion and ensuring those do not overlap with F(H) so that the additional components are blocked by the filter, additional image quality can be obtained. The energy in series expansion tends to be concentrated in lower order terms, so ensuring no overlap with at least F(H*) is useful, the next higher order terms such as F(HH*), F(H²) and F(H*²) are also useful but there comes a point where the impact of each term is small and imposing further constraints has little observable impact on image quality.

The light source may be, for example a laser or other coherent or semi-coherent light source. It may comprise a single emitter or multiple emitters and may emit light having a single wavelength or multiple wavelengths.

The modulator can be any modulator or modulation means suitable for modulating an amplitude and/or phase of coherent or semi-coherent light. This includes Liquid Crystal on Silicon (LCoS) devices, Digital Micromirror Devices (DMD) and Liquid Crystals. In one example, the modulator is a spatial light modulator.

The spatial filter can be any suitable means of forming a Fourier plane and a means for spatially filtering light in that plane. In one example, the spatial filter comprises: a lens having a focal length; and a filter delimiting the aperture. The filter and the modulator are positioned on opposite sides of the lens, at a distance of one focal length from the lens. The lens is preferably a Fourier lens and may be formed from multiple elements. In some examples the lens may be a lens array, where the lenses comprising the array extend over an imaging area.

The modulator, lens and filter may be substantially coaxial in some examples. Other arrangements are also possible, for example a folded optical path with mirror and/or prism elements in the optical path, possibly to allow a more compact arrangement.

The filter delimits an aperture through which light can pass and generally blocks or otherwise prevents light from passing outside the aperture (for example the filter may be configured to absorb light outside the aperture, or to reflect it elsewhere, outside of an optical path).

Further constraints can be placed on F(H) in some examples.

Due to the presence of the filter, less than all of the Fourier plane which can be produced by an SLM is actually used. This may result in display dimming or a reduction in the size of the area in which the displayed hologram can be viewed. While there are no particular constraints on the shape of the perimeter of F(H), providing it meets the non-overlapping requirement with at least F(H*), F(H²), F(H*²) and F(HH*), an analysis of the behaviour of functions in the Fourier plane has shown that well defined areas can be defined. In some examples at least part of a perimeter of the aperture may be a straight line. This may allow a larger area for display than a curved perimeter.

The Fourier plane may be partitioned into a plurality of contiguous unit squares, wherein each unit square receives one copy of the Fourier transform of the target light field. The aperture may then have an area approximately ⅙th of a unit square. As will be explained in more detail later, the unit square is a result of taking the Fourier transform of the discrete grid of the modulator which creates a repeating pattern. A ⅙^{th} area is understood to set a limit on the maximum size of the aperture which can meet the non-overlapping constraint.

In some examples, the perimeter of the aperture is a quadrilateral. Suitable quadrilaterals include rectangles, squares and trapeziums. Some examples use right trapeziums, other examples use isosceles trapeziums for the aperture. (Trapeziums may also be referred to as trapezoids, so a right trapezium is a right trapezoid, and an isosceles trapezium is an isosceles trapezoid.)

While some examples may have a single aperture, in other examples the filter may delimit at least two apertures. The at least two apertures may not be contiguous.

In some examples, the filter comprises a plurality of portions which can be selectively controlled to have a first state, in which light is blocked, or a second state to allow light to pass, whereby the aperture is formed by portions in the second state. This allows the position and extent of the aperture to be controlled as required. For example, with a suitably responsive display, holograms with different positions of target light field may be displayed in rapid temporal succession. This may expand the range of positions in which the displayed hologram can be viewed or to increase a perceived image quality.

As discussed above, the spatial light modulator may be a digital micromirror device (DMD). The display system and methods discussed herein can provide significant improvement to the image quality of a DMD because of its binary nature. In other examples, the spatial light modulator is a Liquid Crystal on Silicon, LCoS, device. Although LCoS devices may have more quantisation states than a DMD, useful increases in image quality are also achieved. When the spatial light modulator is an amplitude-only SLM, such as a DMD, the display system and methods described herein may allow display of holograms with an improved (darker) black level.

The position and size of the aperture is determined with reference to a square with dimensions based on a wavelength of light from the light source. Some examples may use a single wavelength for a monochrome display. In other examples, the light source is configured to emit at least partially coherent light at two or more different wavelengths for a range of color, such as red, green and blue wavelengths that can be switched sequentially for a color display. In one example, the light source is configured to emit at least partially coherent light at a plurality of wavelengths, including green light, and the aperture corresponds to a position of F(H) for green light. Green light may have a wavelength in the range of 495-570 nm or in the range of 520-560 nm, such as around 530 nm. In another example, the aperture corresponds to a portion of F(H) with the at least partially coherent light at a smallest wavelength of the two different wavelengths. In that case, the aperture may only be optimised for one wavelength. Some examples may adjust the size of the aperture to correspond to the wavelength, for example using the aperture with selectively controllable portions discussed above. In other examples, the lens has optical properties configured such that the aperture corresponds to F(H) with the at least partially coherent light at both wavelengths. The optical properties include at least one of a shape and a refractive index.

The light source may be configured to emit at least partially coherent light at a plurality of wavelengths and at least one side of the aperture is angled at 45°. For example, the at least one side may be angled relative to an axis defining a unit square of the Fourier plane. This may be useful because an aperture can be positioned so that the conjugate, F(H*) does not overlap for all wavelengths.

The light source may comprise at least two emitters positioned such that a zero-order of the Fourier plane is in a different position for each of the at least two emitters, and wherein the filter delimits at least two apertures, at least one for each of the at least two emitters. This can allow a greater portion of the Fourier plane to be covered by tiling the apertures for different emitters. Each emitter may have its own respective aperture(s) delimited by the filter, independent from other aperture(s) for the other emitters. The apertures may be at least partially overlapping, such that an aperture for one emitter shares at least part of its open area with an aperture for another emitter. The at least two emitters may be operated in time sequence with their respective apertures. For example a first emitter and a first aperture is activated, followed in time by activating a second emitter and a second aperture.

The light source may comprise a first emitter with a first wavelength and a second emitter with a second wavelength, and wherein the first and second emitter are positioned such that F(H) of one the first and second emitters is contained within F(H) of the other of the first and second emitters. This can mean that the same aperture is suitable for both the emitters.

In accordance with another aspect, there is provided a filter delimiting an aperture that corresponds to a Fourier Transform, F(H), of a target light field, H, in a Fourier plane, wherein the Fourier Transform F(H) does not overlap with (i) its complex conjugate, F(H*), (ii) a Fourier transform of the target light field multiplied by the complex conjugate of the target light field, F(HH*), (iii) a Fourier transform of a square of the target light field, F(H²), and (iv) a Fourier transform of a square of the complex conjugate of the light field F(H*²) in the Fourier plane. Positioning such a filter in a holographic display may allow the display to benefit from the image quality improvements discussed herein, when combined with controlling the display to display a corresponding target light field H. The filter and the aperture may have any of the features discussed above for the filter and the aperture.

In use, the filter may be positioned at different positions in the optical path, such as occupying a “pupil-plane” or an “image-plane”. A pupil-plane is a plane corresponding to an image of the modulator as will be reproduced on a viewer's pupil, and may allow more freedom in the design of the aperture. Pupil-planes, and pupil-like planes, have the property that gaps may be present in the aperture without significantly altering the viewed image. When the filter is not positioned in a pupil-plane or a pupil-like-plane, then it is said to be in an image-plane. When the filter is positioned in an image plane, gaps in the aperture may be visible to a viewer, so that it is preferred to avoid such gaps in the aperture. Examples will be described later with reference to FIGS. 3 and 8.

According to a further aspect, there is provided a method comprising: determining a target light field, H, for quantisation, the target light field having a Fourier transform, F(H), that it does not overlap (i) a Fourier transform of its complex conjugate, F(H*), (ii) a Fourier transform of the target light field multiplied by the complex conjugate of the target light field, F(HH*), (iii) a Fourier transform of a square of the target light field, F(H²), and (iv) a Fourier transform of a square of the complex conjugate of the light field F(H*²); and displaying a quantised version of the target light field through a filter delimiting an aperture corresponding to an extent of F(H) in a Fourier plane such that components corresponding to F(H*), F(HH*), F(H²), and F(H*²) resulting from quantisation are substantially blocked by the filter.

A Fourier transform of the target light field, F(H), therefore is limited in extent and occupies only part of the Fourier plane. While this may result in a dimmer image and/or reduced viewing area, the constraints mean that components introduced by quantisation are filtered and do not reach a viewer's eye, improving image quality.

F(H) may additionally not overlap a Fourier transform of the target light field multiplied by the complex conjugate of the target light field, F(HH*). In further examples F(H) additionally does not overlap at least one of (i) Fourier transform of the square of the target light field, F(H²) and (ii) the Fourier transform of the square of the complex conjugate of the light field F(H*²).

Although the shape or extent of F(H) in the Fourier plane can be anything that meets the constraints, in some examples, an extent of F(H) in the Fourier plane has at least one straight perimeter. The extent of F(H) in the Fourier plane may have a quadrilateral perimeter. The extent of F(H) in the Fourier plane may comprise at least two discontinuous regions.

A target light field having F(H) in the correct region of the Fourier plane can be determined in any suitable manner. For example, it can be determined by applying a mask to an initial light field in the Fourier Plane. In this way the extent of the target light field is limited in the Fourier plane. The initial light field can be a full-complex representation of a target light filter occupying the full addressable extent of the Fourier plane. The mask may be applied in the Fourier Domain by setting values under the mask to zero or a predetermined value.

Display of the quantised image can happen in any suitable way, for example by illuminating a spatial light modulator with coherent or semi-coherent light and controlling the SLM to adopt the inverse Fourier transform of the masked light field.

An advantage of the method of the invention is that it reduces computation requirements, through the positioning of the filter and the limits of F(H), the processing can be thought of as allowing noise to be put into ‘don't care’ areas blind. In other words the aperture design ensures that the noise will be reduced without needing to evaluate the exact noise field. This is unlike Iterative Fourier Transform Algorithms (IFTAs) such as Gerchberg Saxton (GS). In GS and other IFTAs the replay field of the image must be reconstructed computationally and iteratively improved, requiring significant processing resources. Some examples may use IFTA in combination with the aperture. This may allow an improved image quality with reduced processing because fewer iterations are required due the action of the filter to reduce noise.

As such any suitable quantisation method and resolution, quantised in phase and/or amplitude, can be used. For example, the quantisation may be the nearest value that can be reproduced by the display, the nearest value that can be produced by the display without increasing an amplitude, the nearest value that can be produced by the display without increasing a phase, and so on. Some examples may apply a real offset, such as to the masked light field, before quantising. The real value offset may be based on an average amplitude of the values prior to quantisation, such as a root mean square (rms) amplitude. Another example may quantise |H+c|∧2. In such examples the preferred quantisation may not be the quantisation scheme that minimises the total quantisation power at the SLM. If we denote the quantised version of H as H_{Q}, then the quantisation error can be written as an additional noise field, E_{Q}=H_{Q}−H. Ordinarily the total noise power in F(H) would be minimised by minimising E_{Q}, which may be achieved by quantising each pixel to the nearest available value. However, certain quantisation schemes may be used which increase the combined noise power in F(H*), F(H²), F(H*²) and F(HH*), but reduce the noise power in F(H). Such quantisation schemes may increase the noise power E Q compared to nearest-neighbour quantisation, whilst still reducing the noise power in F(H) that is transmitted through the aperture.

The method may comprise generating a plurality of target light fields in different regions of the Fourier domain, each of the plurality of target light fields having the property that an extent of their Fourier transform does not overlap with an extent of the Fourier transform of their complex conjugate; and displaying a quantised version of each of the plurality of target light fields in rapid temporal succession through a respective filter delimiting an aperture corresponding to the extent of their Fourier transform in a Fourier plane. This can increase an area in which the hologram can be viewed.

According to another aspect, there is provided a computer-readable medium, such as a non-transitory computer readable medium, comprising instructions, that, when executed by a processor, cause a holographic display system discussed above to display a holographic image according to the method discussed above.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1A shows an example of the location of the Fourier transform of a hologram, F(H), in the Fourier plane;

FIG. 1B shows the location of F(H*) in the Fourier plane according to the example;

FIG. 1C shows the location of F(HH*) in the Fourier plane according to the example;

FIG. 1D shows the location of F(H²) in the Fourier plane according to the example;

FIG. 1E shows the location of F(H*²) in the Fourier plane according to the example;

FIG. 1F shows a composite of FIGS. 1A-1E illustrating all of the components in the same figure;

FIG. 1G shows the locations of all of the components and all of the copies of the components;

FIGS. 2A to 2F show examples of filters delimiting an aperture;

FIG. 3 shows a filter comprising a plurality of portions according to an example;

FIG. 4 is a schematic diagram showing a holographic display system according to an example;

FIG. 5 shows a method according to an example;

FIG. 6 shows a method of calculating a targeted hologram for display according to an example;

FIG. 7A shows simulated results of the method of FIG. 6;

FIG. 7B shows simulated results of the displaying a quantised hologram without using the method of FIG. 6;

FIG. 8 shows an example using multiple light sources to position the aperture at different locations in the Fourier plane; and

FIG. 9 shows an example of a Fourier plane for two light sources with different wavelengths.

### DETAILED DESCRIPTION

Holographic images are images with depth information that give the perception to a viewer of depth and can be generated by exploiting the electromagnetic wave nature of light. The term images as used herein is understood to include static images as well as moving holographic images comprising a sequence of holographic frames displayed in rapid succession. Furthermore, the present disclosure is relevant to both 2-dimensional and 3-dimensional holograms.

2-dimensional holograms are those which occupy substantially a single image plane but where the image plane can be positioned at a perceived depth from the user. This can allow more comfortable focusing for a viewer's eye especially in augmented reality situations; the hologram can be given a depth matching a point of interest. 3-dimensional holograms give the appearance of a 3-dimensional scene or object with appropriate depth cues for a viewer's eye.

In CGH, a hologram for display is typically first calculated as a “full-complex” hologram which comprises an array of values corresponding to each element (pixel) of a display. Each value is a complex number with respective phase and amplitude. However, many display systems used for CGH images, such as DMD and LCoS spatial light modulators, have a finite range of values that they can reproduce. To display the hologram, each pixel in the full-complex modulated holographic image needs to be mapped, or quantised, to a value that can be reproduced by the display. In one example, the display is a binary display, capable of generating images comprising pixels taking one of two possible amplitude or phase values. An example binary amplitude display is a digital micromirror device (DMD) comprising an array of microscopic actuating mirrors. When illuminated by a light source, each mirror can either direct light to the next component in the optical system, representing a pixel “on” state, or direct light elsewhere, such as towards a heat sink, representing an “off” state. Each mirror can be actuated between the two states as required to generate the desired hologram. Similarly, in a binary phase display, each pixel is capable of emitting light at one of two discrete phases.

Mapping the continuum of full-complex modulated values to quantised amplitude and/or phase values requires a particular quantisation method to be used. A simple example of a binary amplitude quantisation scheme is as follows. If the value has a negative or zero real part (the point is in the second or third quadrant on the Argand diagram), the point is mapped to (0,0) on the Argand diagram. If the value has a positive real component, the point is mapped to the point (0,1) on the Argand diagram. The person skilled in the art will be aware that many alternative quantisation methods can be used and the present disclosure is not limited to any particular quantisation method. However, this example highlights the loss in phase and amplitude information that results from quantising points for display on a DMD. While other display technologies may offer more values, the number of finite states available is still low, perhaps 5 bits (32 values). It is clear that any quantisation will result in a loss of amplitude and phase information, reducing image quality.

The inventors have shown that the noise introduced by quantisation can be reduced by selectively filtering out unwanted noise components in the quantised hologram using a physical filter in the display apparatus. By approximating a quantised representation, H_{Q}, of a target light field as a series expansion, a quantised field can be determined in which additional unwanted components introduced by the quantisation can be filtered out in the Fourier domain/Fourier plane, allowing a much improved approximation of the full-complex target field despite quantisation that has taken place in the display system. The display system and method discussed may provide a computationally inexpensive technique for achieving full-complex modulation using conventional display devices, especially compared to prior iterative software-based techniques, such as Gerchberg Saxton.

H_{Q}≅α+bH+cH*+dH²+eH*²+fHH*+ Eq. 1

Equation 1 above is an expansion of the quantised target light field, H_{Q}. In addition to the desired component H, additional components, H*, H², H*², HH*, . . . are introduced by the quantisation. a, b, c, d, e and f are scalar coefficients whose values depend on the particular quantisation scheme employed. They can be determined numerically but, for the methods described herein, their determination is not essential. It will be appreciated that, as only the H component is desired, the extent to which the rest of the expansion is considered may vary. For example, only the terms in the expansion with the greatest impact (largest coefficient) may be considered. Some examples may consider further components than those in equation 1, such as a H³ term and so on. Other examples may include fewer components than those in equation 1, such as only the H* term.

The quantised Hologram, H_{Q}, is displayed by quantising the initial full-complex hologram, calculated or determined with known techniques, for display. Any suitable display device can be used, including a Spatial light modulator (SLM). The SLM may be, for example, a DMD, an LCD, an Amplitude LCoS, or a phase LCoS. Alight source is configured to generate at least partially coherent light which is modulated by the SLM and may be, for example, a laser or a light emitting diode (LED).

The SLM generates a light field which, when observed by a viewer through an optical system, recreates the light field so the image is perceived. Conventional systems include a lens that creates a Fourier transform of the image displayed on the SLM, with the eye of a viewer causing an inverse Fourier transform to take place. Without applying further steps, such as iterative techniques to account for the quantised values reproducible by the SLM, image quality is low because of the errors introduced by quantisation.

However, the present disclosure makes use of the observation that if a lens having a focal length, f, is positioned one focal length in front of the SLM, such that light modulated by the SLM is incident on the lens, then the Fourier transform of H_{Q}, F(H_{Q}), will be produced one focal length behind the lens. This position is referred to as a Fourier plane of the SLM. This is the plane where the complex amplitude is described by a Fourier transform of the complex amplitude at the SLM, potentially modulo scaling or including a multiplicative spherical phase term. In the present case, the Fourier transform of H_{Q} can be written in terms of the Fourier transform of the series expansion of equation 1 above. Using linearity of the Fourier transform and equation 1, F(H_{Q}) can be expressed as equation 2 below:

F(H_{Q})=αF(1)+bF(H)+cF(H*)+dF(H²)+eF(H*²)+fF(HH*)+ Eq. 2

The components F(H*), F(H²), F(H*²) and F(HH*) will be referred to herein as noise components because they relate to unwanted components generated by quantising the target field, H. It will be understood that the effect of these components could be visible as classical “noise” but could also be a reduction in image contrast and will generally result in reduced image quality.

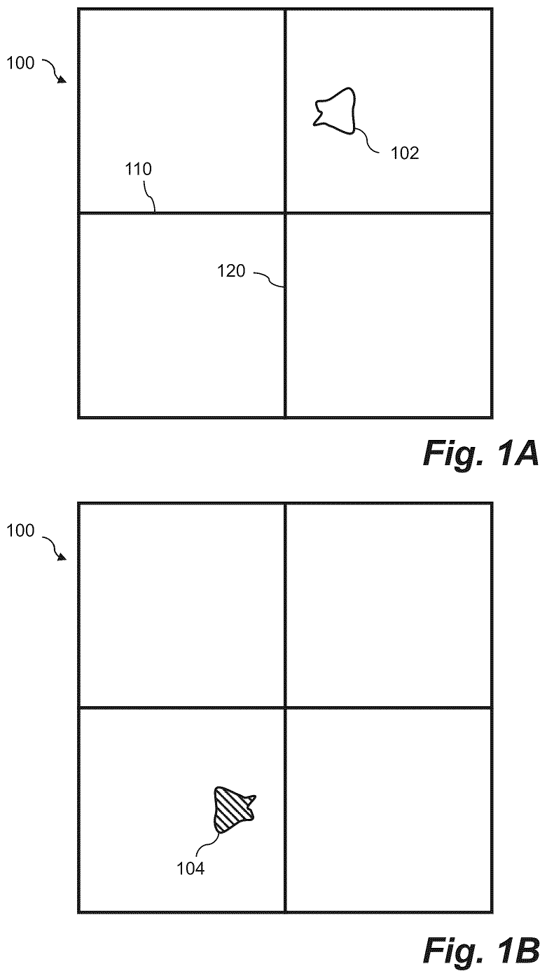

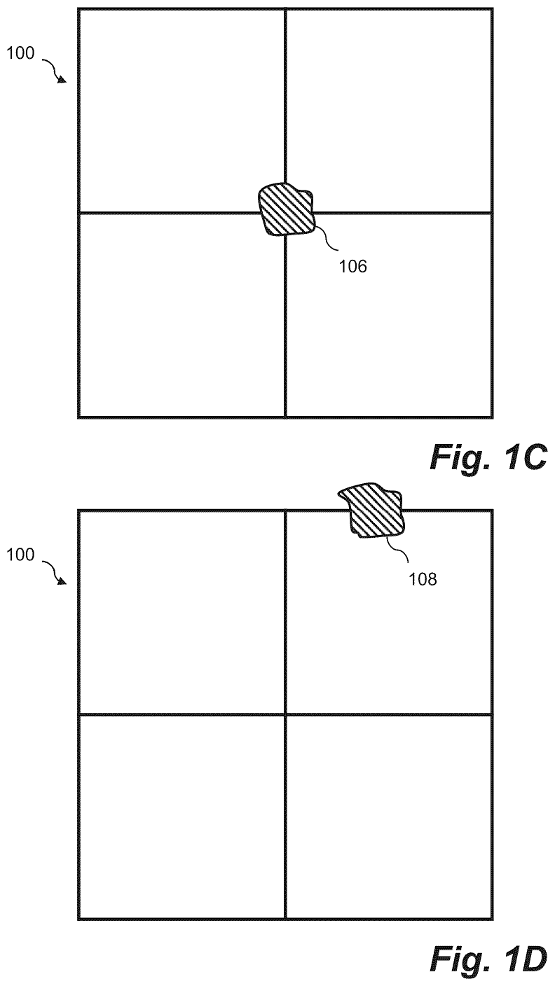

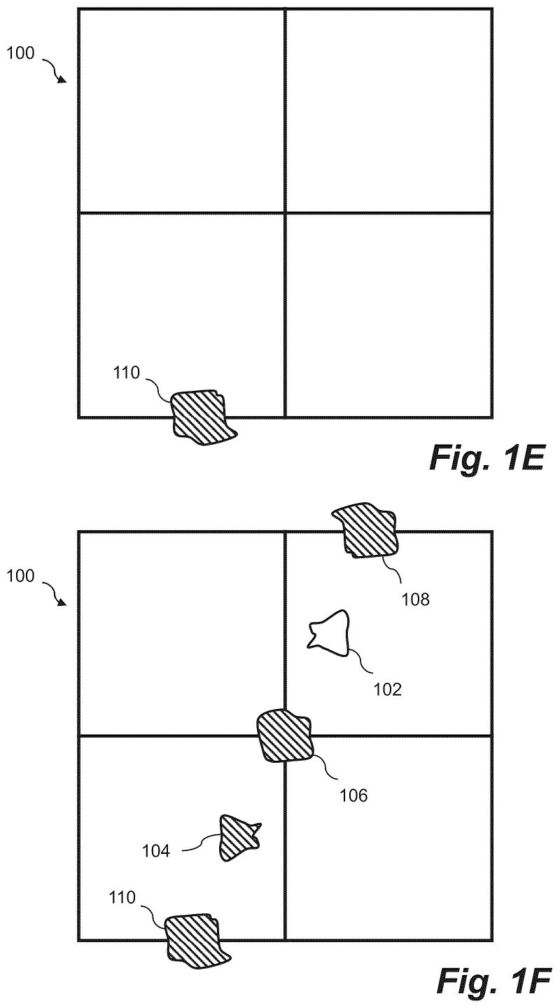

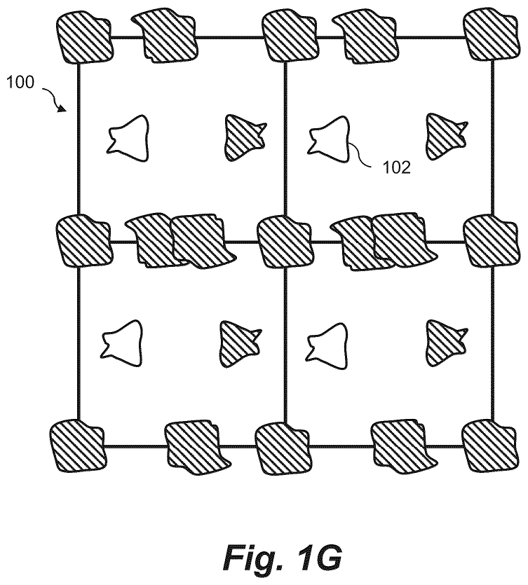

The Fourier transform of a function of space (the target light field, H, is a function of space, H=H(x,y), for example) decomposes that function into its respective frequency components, kₓ, and k_{y}. The Fourier transform of the constant, α, in Eq 1 is a delta function, multiplied by a, and centred at kₓ, =k_{y}=0, as represented by the term αF (1) in Eq 2, and sometimes known as the zero-order diffraction peak. The locations of each of the components on the right-hand side of Eq. 2 in the Fourier plane can be determined from knowledge of the location of F(H) as will now be explained with reference to FIGS. 1A to 1G. FIGS. 1A to 1G are for the purposes of illustration of the general principles used in this disclosure, and the relative locations of noise components.

An example of F(H) 102 targeted at an arbitrary area in the Fourier plane is illustrated in FIG. 1A. FIG. 1A is a plot of the Fourier transform of H in spatial frequency space, with the central horizontal line 110 representing the spatial frequency kₓ axis, and the central vertical line 120 representing the spatial frequency k_{y} axis. Equivalently, FIG. 1A is a plot of the Fourier plane with the horizontal line 110 representing the spatial x axis, and the central vertical line 120 representing the spatial y axis. With this definition, each cell in FIG. 1A is a square with sides of dimension λf/p, where λ is the wavelength of the light illuminating the SLM, f is the focal length of the lens, and p is the pixel pitch of the display. FIG. 1A depicts four cells, centred on the origin to show how the tiling of unit squares influences the aperture design. For example, for illumination with wavelength λ=520 nm, f=60 mm and p=5 μm, the dimension of the square in the Fourier plane is 6.24 mm and this is the size of the filter.

Once the position of F(H) in the Fourier plane is known, the position of the Fourier transform of H*, F(H*), can be determined from the position of F(H). Within the Fourier plane, this is a reflection in the line k_{y}=−kₓ. The result is shown in FIG. 1B, as region 104.

Similar spatial plots in the Fourier plane can be made for the higher order components of the expansion. FIG. 1C shows the position of F(HH*) 106 in the Fourier plane 100. F(HH*) is the Fourier transform of the target light field, H, multiplied by its complex conjugate, H*. Thus, F(HH*) resides in the centre of the Fourier plane and is of double extent of H and H* in kₓ, and k_{y}. FIG. 1D shows the position of F(H²) 108 in the Fourier plane 100, which is also of double extent of F(H) 102 and F(H*) 104 and centred twice as far from the origin as F(H) 102. FIG. 1E shows the position of F(H*²) 110 in the Fourier plane 100. Similarly, F(H*²) 110 is of double extent of F(H) 102 and F(H*) 104 and centred twice as far from the origin as F(H*) 104.

FIG. 1F is a composite of FIGS. 1A-1E and illustrates the relative positions of each component 102, 104, 106, 108, 110 in the Fourier plane 100. Because the target light field, H, is sampled on a grid of pixels, the fields in the Fourier plane repeat on a grid of the squares forming a repeating pattern of the components 102, 104, 106, 108, 110. FIG. 1G shows each of the components depicted in FIG. 1F as well as each of the copies of the components in the Fourier plane. For the location of F(H) 102, none of the noise components introduced by quantisation that were considered in FIGS. 1B to 1E overlap with F(H). Furthermore, none of the other copies of those additional components created by the sampling on a grid overlap with F(H).

It will be appreciated how varying the area occupied by F(H) affects the area occupied by each of the noise components. For example, enlarging the area of F(H) in the Fourier plane causes the noise components to grow correspondingly. Once F(H) reaches a sufficient extent, it will begin to overlap with one or more of the noise components. Further, translating and/or rotating F(H) relative to the origin in the Fourier plane will cause a corresponding translation and/or rotation of the noise components.

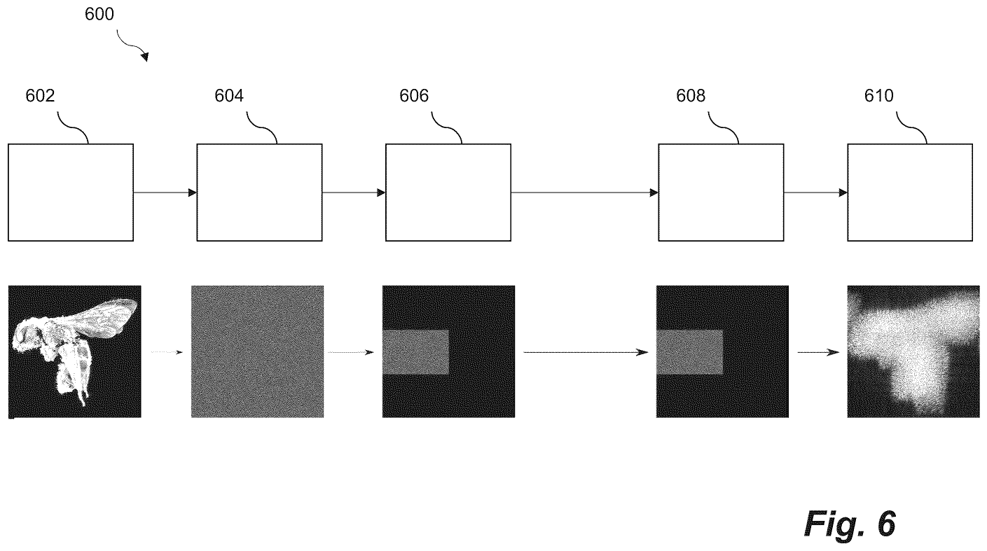

As can be seen from FIG. 1G, the effect of the noise components considered can be removed with a spatial filter in the Fourier plane. An inverse Fourier transform of the resulting filtered Fourier plane will more closely resemble the original full complex function H than will a Fourier transform of an unfiltered Fourier plane. Such filtering can take place physically as part of the display of a hologram, rather than requiring additional calculation steps, such as the multiple iterations of Gerchberg Saxton. As will be explained in more detail below, with reference to FIG. 6, a CGH that targets a particular region of the Fourier plane is relatively easy to determine, such as by applying a masking function. This requires significantly less processing resources and/or power than prior iterative methods.

In an example, the filtering takes place by positioning a filter delimiting an aperture corresponding to the region in the Fourier plane to which F(H) has been targeted. A filter located in the Fourier plane of a lens (for example, where a lens is one focal length from the SLM, the lens's Fourier plane is one focal length at the opposite side), the filter can therefore block the noise components physically. The aperture allows light corresponding to F(H) to pass through the filter and thus reach a target plane where the hologram can be viewed. Selecting the position of F(H) such that there is no overlap of F(H) with the considered noise components ensures that light corresponding to F(H) reaches the target plane while blocking noise components.

As discussed above, once the location of F(H) in the Fourier plane is determined, the locations of the noise components can also be determined, using the method of FIGS. 1A to 1G, for example. Many possible locations of F(H) which do not overlap with considered noise components are possible. Some examples may maximise a region in the Fourier plane subject to the condition that the considered noise components do not overlap F(H). Maximising the region covered by F(H) maximises the amount of light that passes through the filter, increasing the brightness of the hologram at the target plane. This also maximises the area of the hologram in the Fourier plane increasing an area where the hologram can be viewed. The area of the Fourier plane occupied by the hologram corresponds with an “eyebox” of the holographic display system, where a viewer's pupil can be positioned to view the hologram.

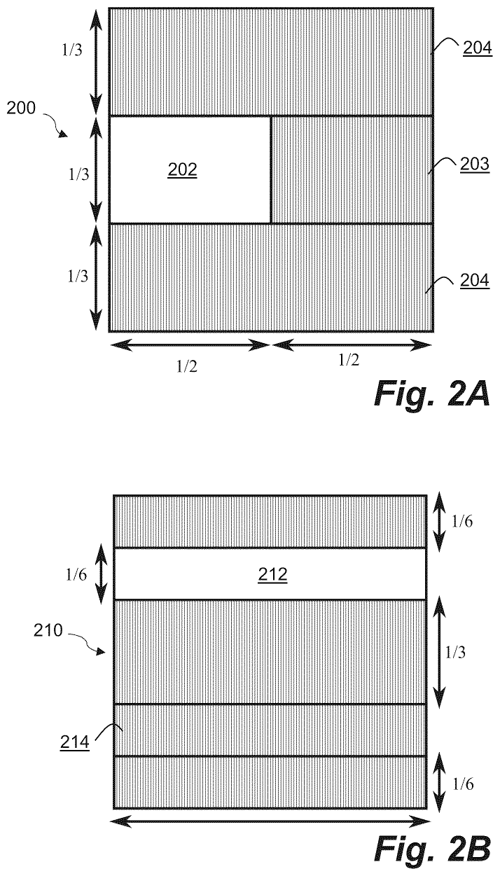

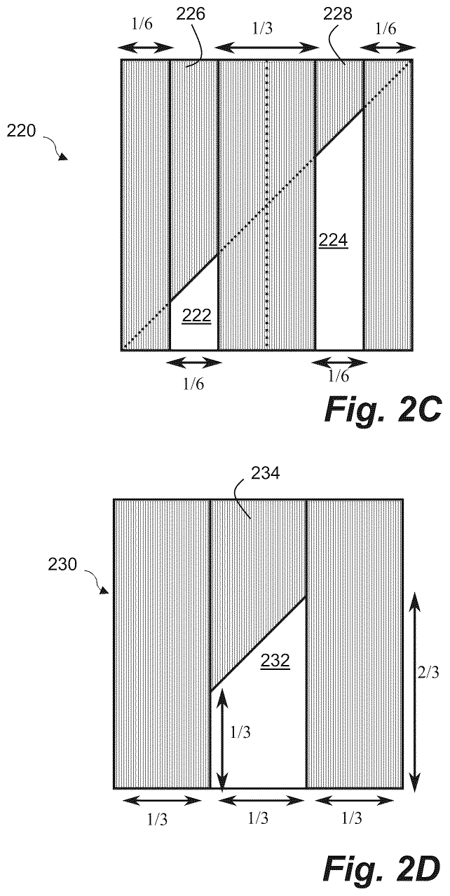

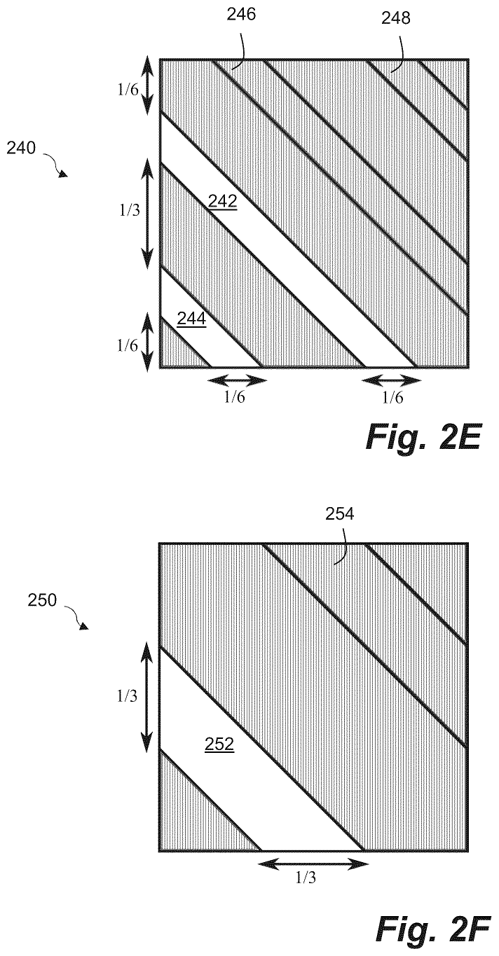

It follows that the maximum area that F(H) can occupy in the Fourier plane, while satisfying the condition of no overlap of noise components relating to F(H*), F(HH*), F(H*²) and F(H²), is ⅙th of the total area of the filter. Further, the shape of the aperture is constrained by the non-overlap condition described above. FIGS. 2A-2E show filters 200, 210, 220, 230, 240, 250 delimiting example apertures 202, 212, 222, 232, 242, 252 satisfying the maximal area condition. It can be seen that none of the apertures 202, 212, 222, 232, 242, 252 are circular. This may be because a circle cannot satisfy the maximal area condition as circles can never completely tile a flat 2-dimensional space.

The filters 200, 210, 220, 230, 240, 250 are shown as unit squares with relative side lengths of 1 for illustration purposes, but in reality will have lengths equal to λf/p. FIGS. 2A-2F delimit filters comprising apertures satisfying the condition that, if F(H) is targeted at the apertures, then at least the noise components considered above for FIGS. 1A to 1G are blocked by the non-aperture portions of the filters and also ⅙ of the area of the unit square is used. FIGS. 2A-2F show just a few of the possible filters that satisfy the above condition and that the filters described herein are therefore not limited to those depicted in FIGS. 2A-2F. Likewise, in some examples filters may not seek to occupy a maximal area and may occupy a smaller area that still satisfies the non-overlap condition. This could allow a “buffer” area between F(H) and its noise components, possibly for more effective filtering and avoiding diffraction effects at a border perimeter of the aperture, or for allowing some more tolerance for alignment of the filter.

FIG. 2A shows an example filter 200 delimiting a rectangular aperture 202 according to an example. The rectangular aperture 202 extends from a side of the filter, in this case from a vertical side and has a width of ½ the width of the filter 200 and a height of ⅓ the width of the filter. More specifically the region is centred on a vertical axis and located at a left side. The rectangular aperture 202 is positioned such that F(H*), F(H²), F(H*²), and F(HH*) are blocked by the filter. Specifically, F(H*) occupies a region 203 adjacent to the aperture 202 along the horizontal axis and occupying the same extent on the vertical axis. F(HH*), F(H²) and F(H*²) occupy regions 204 extending the full width of the filter 200 above and below the aperture 202.

It will be understood that a reflections of filter 200 about a vertical line extending through a centre of the filter, a reflection about a horizontal line extending through a centre of the filter, rotations of 90° about the centre of the filter, reflections about the axes extending through the original of the Fourier plane, and rotations of 90° about the origin are also possible and also satisfy the constraint of non-overlapping noise components. For example, as shown in FIG. 2A, an alternative form may have region 203 as the aperture and region 202 blocked.

FIG. 2B shows another example filter 210 delimiting a rectangular aperture 212. In this case, the height of the aperture 212 is ⅙ the height of the filter and the aperture occupies a position from ⅔ to ⅚ on the vertical axis. The width of the aperture 212 is equal to the full width of the filter 210. Further shown in the filter 210 is a portion or region 214 indicated by solid lines in the filter 210. The portion 214 represents a region where the aperture 212 could instead be positioned and give the same effect. The portion 214 is a reflection and rotation of aperture 212, as discussed above for FIG. 2A.

FIG. 2C shows a filter 220 delimiting two apertures 222, 224, each having the shape of a trapezium and extending from a same side of the filter. More specifically, in this example, the apertures 222, 224 are right trapeziums. Aperture 222 extends from the base or horizontal axis and is centred one quarter of the way along the base of the filter 220 having a base of length ⅙th of the length of the base of the filter 220. The top of the aperture 222 corresponds to a line connecting the lower left corner of the filter 220 to the upper right corner of the filter 220. The top and the base of the aperture 222 are connected by two straight lines perpendicular to the base. Similarly, the aperture 224 is centred ¾ of the way along the base of the filter 220. A central vertical dotted line is shown to indicate halfway along the filter 220 and a diagonal dotted line joining the lower left and upper right corners of the filter 220 is shown to indicate the positions of the tops of the apertures 222, 224. The filter 220 still satisfies the condition that if F(H) is simultaneously targeted at the apertures 222, 224, then the extent of F(H) is maximised without there being any overlap with noise components. As in FIG. 2B, FIG. 2C also shows portions of the filter 226, 228 that could alternatively be delimited as apertures to give the same effect as apertures 222, 224 through rotation and/or reflection of the apertures 222, 224. These portions 226, 228 are again indicated by solid lines in the filter 220.

FIG. 2D shows a filter 230 delimiting a single trapezium-shaped aperture 232 extending from a side of the filter, in this case from a base or horizontal axis. More specifically, the aperture 232 is a right trapezium. The base of the aperture 232 is centred halfway along the base or horizontal axis of the filter 230. The base has a width of ⅓ the length of the filter 230. The left edge of the aperture 232 is a straight line, perpendicular to the base and having a length of ⅓ the width of the filter 230. The right edge of the aperture 232 is a straight line, perpendicular to the base and having a length of ⅔ the width of the filter. The upper ends of the two edges are connected by a further straight line. A portion of the filter 234, indicated by solid lines, shows a region that could alternatively be delimited as an aperture in order to achieve the same effect which is related to region 232 by rotation and/or reflection.

FIG. 2E shows a filter 240 delimiting two apertures 242 and 244 extending between two perpendicular sides of the filter. Each aperture 242, 244 has the shape of a trapezium, more specifically an isosceles trapezium. The aperture 244 has a base ⅙ the width of the filter 240 and centred ¼ the way along the base of the filter 240. The aperture 244 has a left edge with a length ⅙ the width of the filter and centred ¼ the way along the left edge of the filter 240. The lower corner of the left edge is connected to the left edge of the base by a straight line, and the upper corner of the left edge is connected to the right edge of the base by a further straight line.

The aperture 242 has a base centred ¾ the way along the base of the filter 240 and having a length ⅙ the width of the filter 240. The aperture 242 further has a left edge centred ¾ the way up the left edge of the filter and having a length of ⅙ the width of the filter 240. The lower corner of the left edge of the aperture 242 is connected to the left corner of the base of the aperture 242 by a straight line, and the upper corner of the left edge is connected to the right edge of the base by a further straight line.

Portions of the filter 246, 248, shown as solid lines in the filter 240, indicate where the filter could alternatively delimit apertures to achieve the same effect by rotation and/or reflection of the apertures 242, 244.

FIG. 2F shows a filter delimiting a single aperture 252 having the shape of a trapezium, more specifically an isosceles trapezium. The aperture 252 extends between two perpendicular sides. It has a base with length ⅓ the width of the filter 250 centred on the base of the filter. A left edge with length ⅓ the width of the filter 250 is centred on the left edge of the filter 250. The left corner of the base is joined to the lower corner of the left edge by a straight line, and the right corner of the base is joined to the upper corner of the left edge by a straight line. A portion of the filter 254, designated by solid lines in the filter 250, indicates where the filter 250 could alternatively delimit an aperture to achieve the same effect. The portion 254 is related to the aperture 252 by rotation and/or reflection of aperture 252.

It will be appreciated that these are just examples of the shapes of apertures that can satisfy the requirement that F(H) does not overlap with other components of its series expansion in the Fourier plane and the disclosure is not limited to any particular form. For example, although all the filters described above have straight sides, which can be useful to maximise useable area, other examples may use curved sides, or may choose not to maximise useable area of the filter.

While the discussion above has considered maximising the area of the aperture such that all the unwanted components are blocked, some examples may use a still larger aperture. In general, the higher order noise components are not evenly distributed within the Fourier plane and will tend to have a lower power and/or amplitude at their periphery than in the centre. The size of the aperture may therefore be increased slightly beyond the ⅙ criterion described above without introducing too much noise. For example, the aperture may have an area of between ⅕ and ⅙ of a unit square in the Fourier plane and still exhibit improved performance with a hologram targeting the aperture, compared to not targeting the hologram and having no aperture.

The discussion so far has considered apertures that are static, in that their position within the filters does not change in time. In these examples, the maximum area of the filter delimiting the aperture is ⅙^{th} of the total area. While this has the advantages discussed above in terms of improved image quality, it does mean that the area in which the hologram can be viewed is reduced. In further examples, an effective viewable area in which the hologram can be perceived (sometimes referred to as an “eyebox”) can be increased by using a plurality of portions which are selectively controlled to either allow light to pass or to block light from reaching a viewer. The aperture then comprises the portions of the filter that allow light to pass. The portions may be configured to allow at least two of the apertures 202, 212, 222, 232, 242, 252 shown in FIGS. 2A-2F, to be used sequentially. In this way, the position of F(H) within the Fourier plane may be varied over time. Given a suitably fast display, such as a DMD, the display can then rapidly switch between different positions within a single frame period. The viewer will perceive such a series of rapidly displayed holograms as a single hologram, through persistence of vision.

The present disclosure is not however limited to the time-multiplexing technique discussed above being used in combination with the aperture conditions or/and quantisation schemes above. Other algorithmic methods, such as windowed IFTA, may use a delimiting aperture less than the area of a unit square in the Fourier plane (i.e. each sub-aperture spans less than one diffraction order) as a means for increasing image quality. That is, in some examples, windowed IFTA, such as windowed GS, can be utilised to constrain only a sub-region of the Fourier plane and to have a ‘don't care region’ or ‘noise region’ that is blocked by the filter, thereby improving image quality in the chosen sub-region, but at the cost of reducing either the field of view (when the filter is in the image plane) or the eyebox (when the filter is in the pupil plane). The full field of view or eyebox can be reproduced by time-multiplexing each sub-region and blocking the ‘don't care’ regions so that the viewer will perceive a single hologram, through persistence of vision. While this may increase requirements on processing resources, when computational power is available to apply such iterative methods, this may have advantages over other methods known in the art.

When spatial filtering is in an image plane, if the union of all the apertures of the spatial filter has any gaps, or an irregular outline etc, that is visible in the image, and this is constraining on the set of apertures that can be used, and on the specification of the actual physical switchable apertures. However, if the spatial filtering is in the pupil plane, then any gaps or irregular outlines are not apparent to the viewer (if there are gaps, non-uniformities or outlines then these are only visible as slight difference to the bokeh and point-spread-function, which viewers are unlikely to notice).

While One Step Phase Retrieval (OSPR) algorithms also exploit the persistence of vision, the methods of the present disclosure can give higher quality results with lower use of computational resources. In OSPR, many holograms using the entire Fourier plane, but with different random phase patterns, are displayed in rapid temporal succession and the viewer's eye combines them to perceive a single hologram with overall reduced noise (the noise averages out). The concept here uses the same persistence of vision effect, but rather than average out the effect of noise, the averaging is used to increase the portion of the Fourier plane which is used and thus the viewable area. Furthermore, rather than calculate multiple holograms with different random phase patterns, as in OSPR, the method here can simply mask a hologram with the same random phase pattern, which is computationally less intensive. Nevertheless, other examples may use different random phase patterns for each displayed hologram, effectively applying the apertures disclosed herein to OSPR.

Some examples may combine OSPR with the aperture described herein. In that case the OSPR may make use of a lower bit depth because of the noise reduction provided by the aperture. The OSPR becomes less computationally intensive and/or can process frames more quickly to maximise the benefit of the time-averaging effect to reduce noise in OSPR.

The portions can be tiled within each unit cell of the filter so that multiple portions exist per unit cell, i.e. the portion of the filter with dimensions λf/p. The SLM may then be configured to generate the holographic light field, H, so that F(H) is targeted at one or more deactivated portions of the filter. Synchronising the deactivated portions of the filter with the holographic light field generated by the SLM targeting those portions allows an increase in the effective area of the hologram generated at a target plane. If the portions of the filter are activated and deactivated at sufficient speed, such as greater than or equal to 100 Hz, 200 Hz or more, a viewer may not perceive the switches. This allows a further effective increase in the size of the eyebox. As discussed above with reference to FIG. 1C, a central zero-order mode will be formed from the constant term in Equation 2 above, so is always blocked as it contains the highest power of noise terms. However, in some examples, the “zero order” may be located in a different position (such as when echelle gratings are used) and in those examples the part of the Fourier plane containing the highest power noise term is blocked.

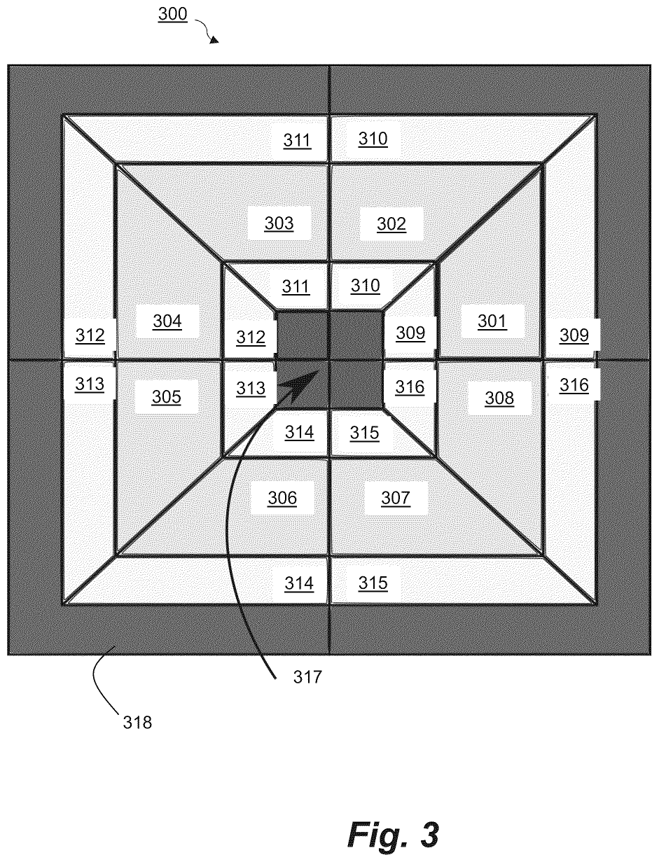

FIG. 3 shows an example of a filter 300 comprising a plurality of portions, corresponding to areas which can be controlled to allow light to pass or not. These are labelled 301 to 316. The portions of the filter 300 correspond to similar apertures to those illustrated in FIGS. 2C and 2D, with rotations and reflections included. More specifically portions 301, 302, 303, 304, 305, 306, 307 and 308 each comprise a single trapezium shaped region as in FIG. 2D, while portions 309, 310, 311, 312, 313, 314, 315 and 316 each comprise two trapezium shaped regions. At any one time, a single one of the apertures 301 to 316 (which may comprise more than one region) is in a state to allow light to pass, while all other portions are in a state where light does not pass. Correspondingly, a holographic light field, H, may be targeted so that F(H) corresponds to the portion(s) that allow light to pass. In use, a controller may supply a suitable hologram to the SLM and control the filter so the relevant portion allows light to pass. Some SLMs may be operated quickly enough that all 16 apertures 301-316 can be displayed in a single frame period. Any sequence of operation can be used, including incrementing from aperture 301 to 316 as labelled and decrementing from aperture 316 to 301 as labelled.

A central portion 317 of the filter 300 corresponding to the zero-order mode is always blocked to prevent light corresponding to F(HH*) and the zero order from passing through the filter 300. Further, with this particular arrangement of portions, an outer region 318 of the filter 300 is always blocked. The filter 300 provides a larger eyebox than is possible with the filters 200, 210, 220, 230, 240, 250 comprising static apertures 202, 212, 222, 232, 242, 252. The presence of the central portion 317, which is always blocked, makes this filter well-suited to use positioned in a pupil-plane: in that case the blocked central portion will not significantly affect the perceived image. The filter can also be used positioned in an image plane, but the blocked central portion may be more visible in that case.

The controllable portions of FIG. 3 can be manufactured in a variety of ways. For example, the filter 300 could be manufactured of liquid crystal and operated to either substantially allow light to pass or substantially block light. The liquid crystal may have a high switching speed such as pi-cell or Ferroelectric LCD (FLCD). Other examples may use a DMD as the filter, where the DMD is controlled not to modulate the light field but to control what parts of the modulated light are allowed to pass through. Another example may use a rotating chopper wheel, with the chopper wheel rotating to define each of the plurality of apertures and the laser synchronised to the chopper wheel. The chopper wheel may use a stepper motor or similar to control rotational position, for example. Of course, the filter 300 could utilise any suitable shutter technology, examples of which include Molecular-based, Quantum Optical and Plasmonic Metamaterials shutters.

Although the filter 300 of FIG. 3 comprises regions which are always blocked, other examples may also allow these blocked regions to be controllable. Such examples allow the spatial filtering to be fully disabled. if required. This may allow a user to choose between operation with spatial filtering, or alternative image processing, such as Gerchberg Saxton iterative processing. Alternatively, or additionally, the filter may be selectively placed in the optical path, such as by providing a mechanism to remove the filter from the optical path when not required and place the filter in the optical path when used with the methods of the present disclosure.

In the previous discussion of FIGS. 2A-2F and 3, F(H) has been discussed as being generated by light of a single illumination wavelength. However, the principles described herein can be extended to cover light of a plurality of illumination wavelengths. Such light could be generated by a plurality of light sources, such as a plurality of single mode lasers, or a single light source operating at a plurality of wavelengths. In the case of multiple illumination wavelengths, the aperture(s) may be selected so that the condition of no overlap of F(H) with the noise components is exact for light of a first wavelength, but only approximate for light of a second wavelength. This allows for approximate full-complex modulation of multicolour holograms.

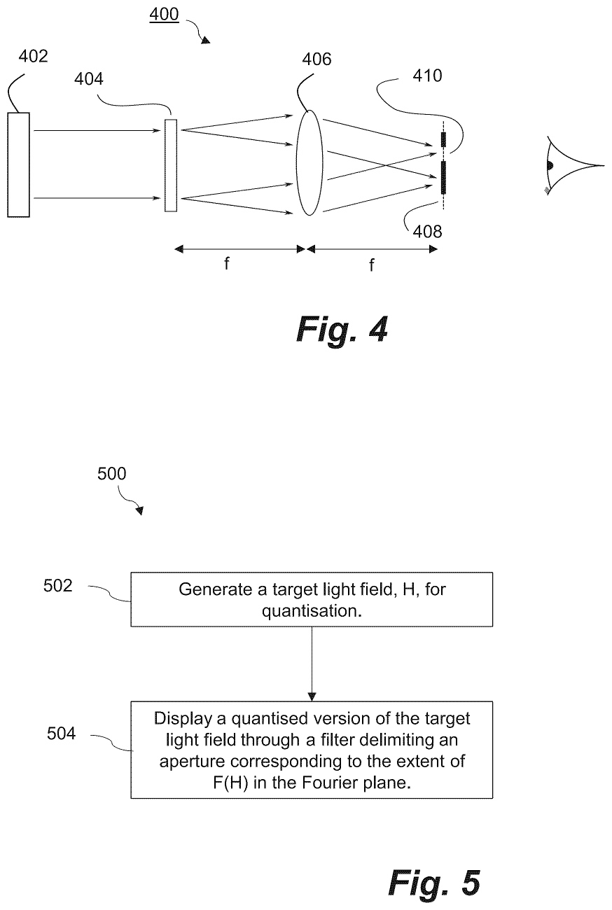

FIG. 4 shows, in general terms, a holographic optical system 400. The system 400 comprises a light source 402 configured to generate at least partially coherent light. The system 400 further comprises a spatial light modulator (SLM) 404 arranged to be illuminated by the at least partially coherent light. The system 400 further comprises a lens 406. The lens 406 has a focal length, f, and is positioned one focal length from the SLM 404. The system 400 further comprises a filter 408 delimiting an aperture 410. The filter 408 is positioned one focal length from the lens 406, on the opposite side of the lens 406 from the SLM 404.

The SLM 404 is configured to generate a light field which is a quantised representation of a target light field, H, as has been discussed above. The arrangement of the holographic optical system 400 is such that the Fourier transform of the light field, F(H), is formed at a plane coinciding with the position of the filter 408. This plane is the Fourier plane of the SLM 404 as imaged by the lens 406. The target light field is determined such that the Fourier transform of the target light field, F(H), does not overlap at least the Fourier transform of the complex conjugate of the target light field, F(H*) and the second order components in the Fourier plane of the SLM 404. Further, the aperture in the filter 408 corresponds to F(H) in the Fourier plane, such that portions of the target light field outside of F(H) are blocked.

The light source 402 may, for example, comprise a laser module or an LED. The light source 402 is configured to generate at least partially coherent light at one wavelength, or a plurality of wavelengths (corresponding to red, green and blue, for example).

The SLM 404 may be configured to modulate at least one of the phase, amplitude, binary phase and binary amplitude of the light. The SLM 404 may be, for example, a DMD, an LCD, an amplitude LCoS or a phase LCoS.

The filter 408 corresponds to the area targeted by F(H) and may be any of the filters shown in FIGS. 2A-2F and 3 with configurations as discussed above. As shown, the SLM 404, lens 406 and filter 408 are coaxial. Other configurations may also be used, such as a folded light path that may allow a more compact display.

For clarity, FIG. 4 depicts a transmissive SLM, it will be understood that the principles discussed here are not limited to this and can equally be applied to reflective SLMs. Likewise, the same principles apply to other types of modulator than a SLM.

Having explained the theory and overall construction of a holographic display according to the present disclosure, its method of operation will now be explained. FIG. 5 shows a method 500 of reducing quantisation noise in a holographic image. The method 500 can be executed by a controller of the holographic optical system 400 shown in FIG. 4, for example. At 502, the method 500 comprises generating a target light field, H, for quantisation. The target light field has a Fourier transform, F(H), with the property that it does not overlap its complex conjugate, F(H*) and the second order components in the Fourier plane. F(H) can be predetermined as occupying a region with these properties, for example as discussed above with reference to FIGS. 2 and 3. A method for targeting the hologram at this region is described below with reference to FIG. 6.

Next, at 504, a quantised version of the target light field is displayed through a filter delimiting an aperture corresponding to the extent of F(H) in the Fourier plane, such that at least the Fourier transform of its complex conjugate, F(H*) and the second order components, are blocked by the filter.

FIG. 6 shows an example method 600 for calculating a hologram to be targeted at a pre-defined region of the Fourier plane, along with example representations of an image at each step, showing the effect of the processing. The method 600 can be performed by a processing system which may be local or remote from the holographic display system. Holographic frames determined by method 600 are output to an SLM, such as SLM 404.

The method 600 begins at block 602 by receiving a target light field. The target light field is a 2-dimensional array representing one image layer to be displayed by the holographic optical system. The target light field is converted into a complex target light field 602 by applying a respective random phase factor, eⁱ⁹, to each pixel. This acts to rotate each pixel value in the complex plane, giving each pixel an imaginary component. The phase values have a statistically uniform distribution across the light field. Each random phase factor may comprise a matrix of random numbers to be applied to a target light field comprising a matrix of pixels.

At block 604, the complex target light field undergoes a Fourier transform (such as a Fast Fourier Transform, FFT) to simulate the light field at a viewer's pupil. The simulated pupil is then masked at block 606 to form an apertured pupil. Applying a mask could be setting the amplitude to zero, for all portions of the simulated light field outside the aperture. The apertured pupil is a subregion of less than all the field from block 604, wherein the shape of the subregion is dictated by the particular mask used. In practice, the particular mask used coincides with the aperture selected in the filter of the holographic optical system. For example, as shown in FIG. 6, the mask at block 606 used to form the apertured pupil corresponds to the aperture 202 shown in FIG. 2A. In the method 600, the resulting F(H) will be targeted at an area in the Fourier plane corresponding to the aperture 202.

So far, the image will be perceived as positioned at infinity, so at block 608 a defocus Zernike polynomial is applied to the output of block 606 resulting in a defocussed image at a target depth on a plane coinciding with the SLM. In general, the properties of the defocus Zernike polynomial are determined by the parameters of the holographic optical system. For example, the SLM has N×M pixels and a pixel pitch p. A lens with a focal length, f is positioned one focal length from the SLM, and the SLM is illuminated with light of a single wavelength, A. For a layer at depth d, and an SLM at optical infinity, the apertured pupil 606 is multiplied by a defocus Zernike: exp(2πi(2r²−1)/4dλ), where r is the radial distance (in metres) of each sample point from the centre of the apertured region. The spatial sampling of the pupil is fλ/pN in the x-direction and fλ/pM in the y-direction, from which the value of r for each point can be determined. The method is not limited to the use of Zernike polynomials, other methods may be used such as a parabolic phase function.

By applying the defocus Zernike polynomial after the masking at block 606, the processing required may be reduced because the extent of the field is smaller than if the polynomial was applied after block 604. However, block 608 may occur after block 604 and before block 606 in some examples.

The defocussed apertured pupil from block 608 undergoes an inverse Fourier transform at block 610, resulting in a light field at the depth of the SLM. It can be observed that although the aperture is restricted in the Fourier plane, the inverse Fourier transform means that the full extent of the SLM is still used to display the image. (In the same way that filtering a time-varying waveform in the Fourier domain still results in a time domain waveform of the same length in time, filtering the Fourier plane still results in the full extent of the SLM being used for display.)

The resulting light field from block 610 can then be quantised to form a quantised representation of the resulting light field. Any suitable quantisation scheme can be applied, as discussed above. The process 600 determines a holographic light field to be formed by an SLM, such as the SLM 404, such that the Fourier transform of the light field is formed in an area of the Fourier plane corresponding to a pre-defined aperture in a filter.

Looking at FIG. 6, the image at block 610 appears to be of lower quality than at block 602. This is for several reasons. Firstly, the image at block 602 is ideal so the image at block 610 cannot be of higher quality. Secondly, the image at block 610 shows the effect of the defocus Zernike Polynomial. If the aperture was not present, then the image at block 610 would be of lower quality than depicted.

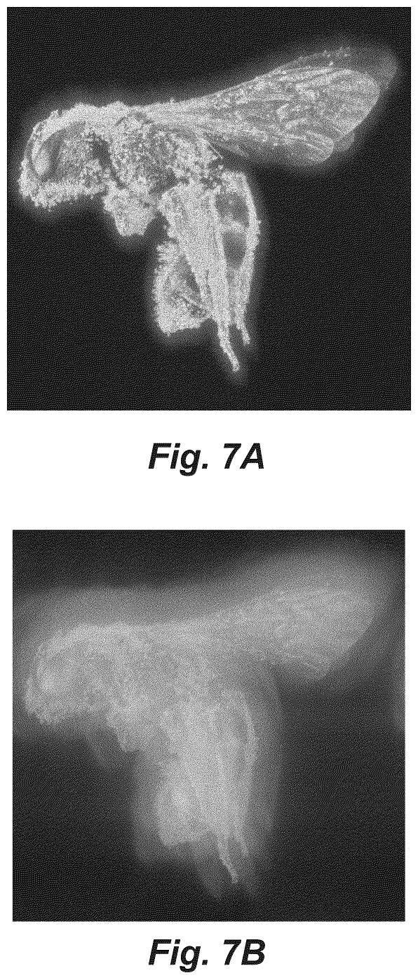

FIG. 7A shows a simulated result of the method of FIG. 6, using the aperture described above together with targeting of F(H) to the aperture. FIG. 7B shows a simulated result of displaying the quantised field H without using the aperture and of targeting F(H) to the aperture. FIG. 7B is noticeably lower quality than FIG. 7A.

As discussed so far, FIG. 6 considers a single image layer. This can provide a holographic image at a correct depth with focus cues for the viewer's eye. The person skilled in the art will know that the process of FIG. 6 can be repeated for multiple layers at different distances (with corresponding defocus Zernike polynomials), with each layer calculated independently and summed together to generate a 3-dimensional scene.

In some examples the filter comprises a plurality of portions that can be selectively controlled to pass or block light, such as the filter 300 shown in FIG. 3. In this case, different portions can be activated and deactivated sequentially to enlarge the effective eyebox of the resulting hologram. Using the process 600, it is clear that targeting F(H) at different regions of the Fourier plane can be achieved simply by applying the corresponding masks to the simulated pupil determined at block 604 to generate an appropriate apertured pupil at block 606. Thus, if there are 16 regions to target, as with the example of FIG. 3, blocks 606, 608 and 610 are repeated for each aperture. The holographic display is then controlled to display the resulting complex field at the same time as the corresponding aperture is enabled to pass light through the filter.

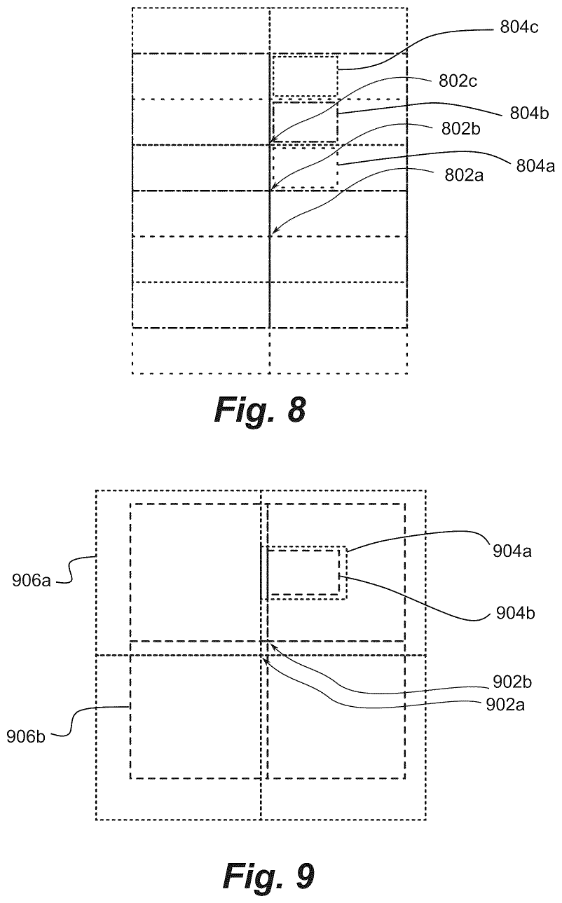

FIG. 8 depicts another way in which a larger area of the Fourier plane can be covered, this time by using multiple light sources, each illuminating the modulator from different angles. The change in angle means that the Fourier plane of each light source is located at a different position, in effect translating the position of the zero order in the Fourier plane. FIG. 8 shows this effect diagrammatically, with three light sources resulting in Fourier planes with a zero-order located at respective positions 802a, 802b, and 802c. Using the aperture discussed above with reference to FIG. 2A, the aperture is therefore positioned at 804a, 804b and 804c in the Fourier plane. In use, the light sources are operated in time sequence and the position of the aperture is synchronised to the light source. From FIG. 8, it can be seen how this allows a larger area of the Fourier plane to be covered. Throughout this process the data displayed by the modulator also operates in a corresponding time sequence synchronised to the light source, while the change in position of the aperture is due to the different angle of the light source.

The apertures of FIG. 8 allow substantially uniform coverage of the Fourier plane, avoiding the central blocked portion 317 of FIG. 3, for example. This makes it well-suited to use at any position of the filter, but it may be useful when the filter is positioned in an image plane.

As shown in FIG. 8, there is a single aperture 804a, 804b, 804c per light source, but multiple apertures per source could additionally be time multiplexed for each source to fill an even larger area. For example, the offset sources of FIG. 8 could be combined with the multiple aperture positions of a single source for FIG. 3. Similarly, other shapes of aperture can be used, as described above.

FIG. 9 depicts an example of a Fourier plane 906a, 906b for two light sources with different wavelengths. The light sources are physically separate in this example, so the zero-order is located in different positions 902a, 902b. In addition, as explained above, the different colour of the source means that the different wavelength causes the Fourier plane to be scaled and the dimensions of the unit square to change. In this example, the angle and/or position of the source relative to the modulator has been chosen so that the aperture 904b is located within aperture 904a, in this case it is wholly located within aperture 904a. Without this shift of the source angle or position it is possible that the apertures 904a, 904b would not fully overlap, reducing performance. In use, using the aperture 904b for both light sources will give the benefit of noise reduction for both sources, but slightly reduced brightness for one source because the full extent of aperture 904a is not used.

As shown in FIG. 9, there is a single aperture 904a, 904b per light source, but multiple apertures per source could additionally be time multiplexed for each source to fill a larger area. For example, the offset sources of FIG. 9 could be combined with the multiple aperture positions of a single source for FIG. 3. Similarly, other shapes of aperture can be used, as described above.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A holographic display system comprising:
a light source configured to emit at least partially coherent light;
a modulator arranged to be illuminated by the at least partially coherent light and to generate a light field which is a quantised representation of a target light field, H; and
a spatial filter delimiting an aperture in a Fourier plane;
wherein
a Fourier transform of the target light field, F(H), substantially does not overlap (i) a Fourier transform of a complex conjugate of the target light field, F(H*), (ii) a Fourier transform of the target light field multiplied by the complex conjugate of the target light field, F(HH*), (iii) a Fourier transform of a square of the target light field, F(H²), and (iv) a Fourier transform of a square of the complex conjugate of the light field F(H*²); and
the aperture substantially corresponds to F(H) in the Fourier plane.

2. The holographic display system according to claim 1, wherein the spatial filter comprises:
a lens having a focal length; and
a filter delimiting the aperture;
wherein
the filter and the modulator are positioned on opposite sides of the lens, at a distance of one focal length from the lens.

3. The holographic display system according to claim 1, wherein at least part of a perimeter of the aperture is a straight line.

4. The holographic display system according to claim 1, wherein the Fourier plane is partitioned into a plurality of contiguous unit squares, wherein each unit square receives one copy of the Fourier transform of the target light field, and wherein the aperture has an area approximately ⅙th of a unit square.

5. The holographic display system according to claim 1, wherein a perimeter of the aperture is a quadrilateral.

6. The holographic display system according to claim 1, wherein the filter delimits at least two apertures.

7. The holographic display system according to claim 1, wherein the filter comprises a plurality of portions which can be selectively controlled to have a first state, in which light is blocked, or a second state to allow light to pass, whereby the aperture is formed by portions in the second state.

8. The holographic display system according to claim 1, wherein the modulator is a digital micromirror device.

9. The holographic display system according to claim 1, wherein the modulator is a Liquid Crystal on Silicon, LCoS, device.

10. The holographic display system according to claim 1, wherein the light source is configured to emit at least partially coherent light at a plurality of wavelengths, including green light, and the aperture corresponds to a position of F(H) for green light.

11. The holographic display system according to claim 1, wherein the light source is configured to emit at least partially coherent light at a plurality of wavelengths, and at least one side of the aperture is angled at 45°.

12. The holographic display system according to claim 1, wherein:
the light source comprises at least two emitters positioned such that a zero-order of the Fourier plane is in a different position for each of the at least two emitters, and wherein the filter delimits at least two apertures, at least one for each of the at least two emitters.

13. The holographic display system according to claim 1, wherein the light source comprises a first emitter with a first wavelength and a second emitter with a second wavelength, and wherein the first and second emitter are positioned such that F(H) of one the first and second emitters is contained within F(H) of the other of the first and second emitters.

14. A method of displaying a holographic image, the method comprising:
determining a target light field, H, for quantisation, the target light field having a Fourier transform, F(H), such that it does not overlap (i) a Fourier transform of its complex conjugate, F(H*), (ii) a Fourier transform of the target light field multiplied by the complex conjugate of the target light field, F(HH*), (iii) a Fourier transform of a square of the target light field, F(H²), and (iv) a Fourier transform of a square of the complex conjugate of the light field F(H*²); and
displaying a quantised version of the target light field through a filter delimiting an aperture corresponding to an extent of F(H) in a Fourier plane such that components corresponding to F(H*), F(HH*), F(H²), and F(H*²) resulting from quantisation are substantially blocked by the filter.

15. The method of claim 14, wherein an extent of F(H) in the Fourier plane has at least one straight perimeter.

16. The method of claim 14, wherein an extent of F(H) in the Fourier plane has a quadrilateral perimeter.

17. The method of claim 14, wherein an extent of F(H) in the Fourier plane comprises at least two discontinuous regions.

18. The method of claim 14, wherein the generating the target light field comprises applying a mask to an initial light field.

19. The method of claim 14, comprising:
generating a plurality of target light fields in different regions of the Fourier domain, each of the plurality of target light fields having the property that an extent of their Fourier transform does not overlap with an extent of the Fourier transform of their complex conjugate; and
displaying a quantised version of each of the plurality of target light fields in rapid temporal succession through a respective filter delimiting an aperture corresponding to the extent of their Fourier transform in a Fourier plane.

20. A non-transitory computer-readable medium comprising instructions, that, when executed by a processor of a holographic display system, cause the holographic display system to display a holographic image by:
determining a target light field, H, for quantisation, the target light field having a Fourier transform, F(H), such that it does not overlap (i) a Fourier transform of its complex conjugate, F(H*), (ii) a Fourier transform of the target light field multiplied by the complex conjugate of the target light field, F(HH*), (iii) a Fourier transform of a square of the target light field, F(H²), and (iv) a Fourier transform of a square of the complex conjugate of the light field F(H*²); and
displaying a quantised version of the target light field through a filter delimiting an aperture corresponding to an extent of F(H) in a Fourier plane such that components corresponding to F(H*), F(HH*), F(H²), and F(H*²) resulting from quantisation are substantially blocked by the filter.
